(19) United States
(12) Patent Application Publication
(10) Pub. No.: US 2011/0022589 A1
(43) Pub. Date: Jan. 27, 2011

(54) ASSOCIATING INFORMATION WITH MEDIA CONTENT USING OBJECTS RECOGNIZED THEREIN

(75) Inventors: Claus Bauer, Beijing (CN); Jack Buser, San Francisco, CA (US)

Correspondence Address: Dolby Laboratories Inc., 100 Potrero Avenue, San Francisco, CA, 94103-4938, US

(73) Assignee: DOLBY LABORATORIES LICENSING CORPORATION, San Francisco, CA (US)

(21) Appl. No.: 12/935,082

(22) PCT Filed: Mar. 31, 2009
(86) PCT No.: PCT/US09/38878

§ 371 Date: Sep. 28, 2010

Related U.S. Application Data
(60) Provisional application No. 61/040,871, filed on Mar. 31, 2008.

(51) Int. Cl. G06F 17/30

(52) U.S. Cl. 707/723; 707/E17.084

(57) ABSTRACT

At least one object within a portion of media content is recognized. The object is essentially a feature of the media content portion. Information is associated with the recognized object based on recognizing the object.

### PRIORITY CLAIM TO RELATED APPLICATION

This Application claims the benefit of co-pending Provisional U.S. Patent Application No. 61/040,871 filed on Mar. 31, 2008 by Claus Bauer and Jack Buser, entitled Distributed Media Fingerprint Repositories (with Patent Docket No. D08002US01), which is incorporated by reference for all purposes as if fully set forth herein.

### TECHNOLOGY

The present invention relates generally to media. More specifically, embodiments of the present invention relate to associating information with media content using objects recognized therein.

### BACKGROUND

Video and other media comprise a widespread feature of modern activity. Modern enterprises and individuals from many walks of life use video and related media content in a wide variety of both unique and related ways. Entertainment, commerce and advertising, education, instruction and training, computing and networking, broadcast, enterprise and telecommunications, are but a small sample of modern endeavors in which video and related media content find common use.

Video media include movies and other recorded performances, presentations and animations, and portions thereof. Video media content may be streamed or stored in various formats, such as on Digital Versatile Disks (DVD), Blu-Ray (BD) and other high capacity/definition media storage platforms, hard drives, flash drives and the like and may be processed and presented with computers, televisions, portable players of digital media files, cellular telephones, personal digital assistants (PDA) or the like.

As a result of its widespread and growing use, vast quantities of audio and media content exist. A large quantity and variety of video and related (e.g., graphical, photographic, text based, etc.) exists and expands over time.

Approaches described in this section could be pursued, but have not necessarily been previously conceived or pursued. Unless otherwise indicated, it should not be assumed that any approaches described in this section qualify as prior art merely by virtue of their inclusion herein. Similarly, issues identified with respect to one or more approaches should not be assumed to have been recognized in any prior art on the basis of this section, unless otherwise indicated.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a flowchart for a first example procedure, according to an embodiment of the present invention;

FIG. 2 depicts an example system, according to an embodiment;

FIG. 3 depicts a flowchart for a second example procedure, according to an embodiment;

FIG. 4 depicts a flowchart for a third example procedure, according to an embodiment;

FIG. 5 depicts an example computer system platform, with which an embodiment may be implemented;

FIG. 6 depicts a flowchart for a fourth example procedure, according to an embodiment; and

FIG. 7 depicts a second example system, according to an embodiment.

### DESCRIPTION OF EXAMPLE EMBODIMENTS

Example embodiments relating to associating information with media content using objects recognized therein are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Information associated with the identified object thereof may include advertisements. Information associated with a recognized object may be described or referred to herein as “associated information” thereof or the like. In addition to (or instead of) advertisements, associated information may include commercial, educational, aesthetic, instructional, technical, social, personal, or other information, which may relate in some sense to the media content. Associated information may include video, audio, textual, graphical, and/or haptic based content.

### Overview

Example embodiments relate to associating information with media content using objects recognized therein. At least one object within a portion of media content is recognized. The object is essentially a feature of the media content portion. Information may be associated with an object, upon recognition thereof, e.g., with an identity associated with or corresponding to the object.

The object may be recognized during play out and/or upload of the media content portion. Associating information with content may include identifying the recognized object, mapping the associated information to the identified object, and providing the associated information with the media content portion in which the recognized object appears as a feature. An embodiment presents the associated information in essentially real time. For example, the associated information may be presented in real time or near real time in relation to playout of the media content portion that has the recognized object as a feature therein.

Mapping the associated information to the identified object may occur upon (or before, e.g., precomputed queries such as views) a query received over an information repository in relation to the identified object. The information repository, for example, a database, may comprise a catalog of multiple identified objects, each arranged in database entries in relation the identity of the objects. A database index of the catalog relates one or more of the identified objects in relation to one or more information sources, which include a source of the associated information. In response to the query, the associated information is indexed to the identified object. A link to the associated information may be sent (or accessed) to the information thus indexed.

The media content may be an essentially original instance of the media content or an instance of content that conforms substantially thereto. The media content may also be an instance of content that is derived from either. Derivative media content instances may substantially conform to an original content instance (or one substantially conforming thereto). Derivative media content instances may also be modified in relation to an original content instance. For example, derivative content may be modified in relation to an original content instance with respect to editing, scaling, transcoding, and/or distortion. Derivative content may be a segment or snippet of an original content portion, and may thus vary therefrom in relation to duration, context, content volume or the like.

### Definitions, Nomenclature, References & Examples

As used herein, the term “medium” (plural: “media”) may refer to a storage or transfer container for data and other information. As used herein, the term “multimedia” may refer to media which contain information in multiple forms. Media information files may, for instance, contain audio, video, image, graphical, text, animated and/or other information, and various combinations thereof. The term “object,” as used herein in relation to media content such as a video file, an image, similar media content or portion thereof, may refer to a feature of (e.g., shown within or comprising a part of) the media content. For example, objects in or of a video file or image may include a picture of a car, a person, an animal, etc. Terms such as “associated information,” “associated content,” “auxiliary content,” and “auxiliary information,” as used herein in relation to a video, multimedia or other media content file, may refer to information that is indexed by a certain part of the media content file. Thus, the terms “auxiliary content” or “associated information,” as used herein in relation to an object may refer to a (e.g., any) piece of information that may be indexed by an object.

The information itself may not necessarily correspond in any particular way to any part of the media object itself For example, an object or a portion thereof may index the temperature in New York City at a certain day or time. Alternatively or additionally, a media object or a portion thereof may index a certain model and manufacturing year of a particular model of a given car manufacturer. Such indexing may be independent of the production or creation of media content such as a movie, video, or picture.

As used herein, the terms “link,” “linked,” “linking” and the like may refer to storing one or more pointers to auxiliary content in a repository such as a database or list of objects recognized within a portion of media content (which may be referred to herein as “recognized objects”), storing one or more universal resource locators (URL) of one or more locations that contain auxiliary content in a repository such as a database or list of recognized objects, storing one or more database references that contain auxiliary content in a repository such as a database or list of recognized objects, or the like. As used herein, the term “links” may refer to retrieving auxiliary content from one or more pointers stored in a repository such as a database or list of recognized objects, retrieving auxiliary content from one or more files referred to by a repository such as a database or list of recognized objects retrieving auxiliary content using one or more URLs stored in a repository such as a database or list of recognized objects, retrieving auxiliary content from one or more database references stored in a repository such as a database or list of recognized objects, or the like.

An embodiment enables linking of an object in a video file, image, or multimedia file to auxiliary content during playback or upload of the file. Embodiments function with situations in which a whole media file or portions thereof are played back on different sets of devices, with different lengths or runt times, and with or after various modifications of the video file. Modifications may include, but are not limited to, include editing, scaling, transcoding, and generating derivative works (e.g., insertion of original or instances of media content into other media, such as new media content).

Embodiments function to allow identification of auxiliary content that was assigned to the specific object in a multimedia file even when the file is played back or uploaded as a whole or in parts, sequences, original or substantially original state or modified, etc. Moreover, embodiments may function independent of the insertion or generation of metadata relating to the content or any modification of the content. Embodiments may function with multimedia content playback or upload, such as may comprise both audio and video content.

Embodiments allow identification of originally assigned auxiliary content. In an embodiment, video object recognition is used for identifying objects or indexing auxiliary content in relation thereto. An embodiment may use one or more computer vision related techniques for object recognition, such as the recognition of objects within video or image files or other media content from local scale-invariant features associated with the objects.

In an implementation, an entity maintains a repository such as a database, which maps objects or classes of objects to specific auxiliary content originally assigned to the objects or groups of objects. When media content is accessed or presented, for example, when a part of a movie is played on (or uploaded to) a webpage like “Facebook” or “YouTube,” or played out as regular broadcast programming from a television network, object recognition of the played part is performed in essentially real-time in relation thereto. The mapping database is queried, which allows linking to the auxiliary content was originally assigned to this part of a movie.

An embodiment allows an advertiser to “purchase”, buy, rent, pay a fee for, or otherwise exchange consideration in remuneration for associating an advertisement in essentially real time with scenes of a video, a feature of which comprises certain objects. For example, a soft drink company may identify one or more scenes in a movie or a portion thereof in which an actor is drinking a specific product. The soft drink company may purchase the right to display an advertisement associated with their product with (e.g., in real time or near real time, and/or proximate to the media content display) presentation of the media content portion that includes the recognized object as a feature therein. The advertisement may be presented next to or on top of the video content when the object appears in the movie. Whenever parts of the movie play out on any device with an internet connection, the object in part of the movie may be identified using object recognition, the purchaser and the play-back webpage may be informed, and depending on an agreement between the playback webpage and the advertiser entity, a related advertisement defined by the advertisement purchaser may be shown in parallel with or soon after the specific piece of movie in which the identified object appeared as a feature. An embodiment functions with an original content instance, a content instance that substantially conforms to an original instance thereof (e.g., an authorized copy, a DVD, etc.), or where the same scene containing the respective object is used in derivative content, such as with a trailer, an advertisement, or copied instances of the content that are “pirated” for a social networking site. In each situation, the object is recognized as a feature in the scene and linking to the auxiliary content is performed.

### Example Embodiments

### Example Procedures

The example procedures and methods described herein may be performed in relation to associating information with media content using objects recognized therein. Procedures that may be implemented with an embodiment may be performed with more or less steps than the example steps shown and/or with steps executing in an order that may differ from that of the example procedures. The example procedures may execute on one or more computer systems, e.g., under the control of machine readable instructions encoded in one or more computer readable storage media, or the procedure may execute in an ASIC or programmable IC device.

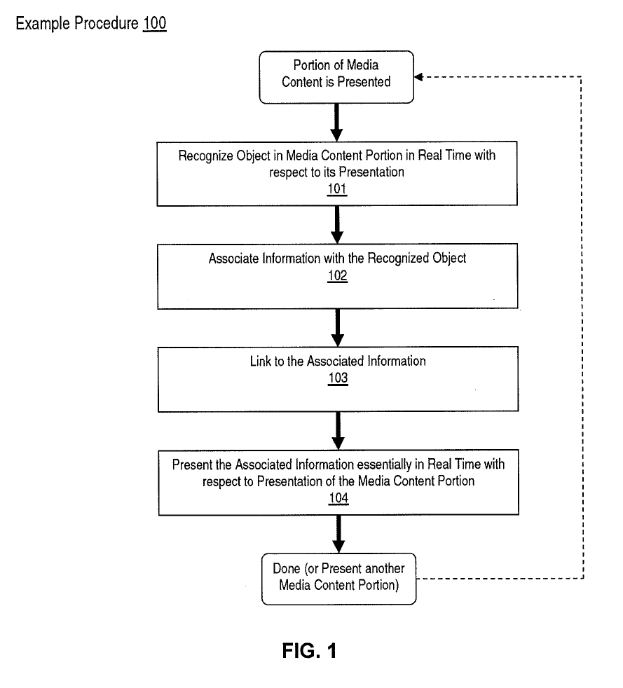

FIG. 1 depicts a flowchart for a first example procedure 100, according to an embodiment. Procedure 100 relates to associating information with media content using objects recognized therein. Initially, the portion of media content, such as a video clip, or a certain part of movie, is presented. For example, the media portion may be presented as a user is viewing the movie in a video format.

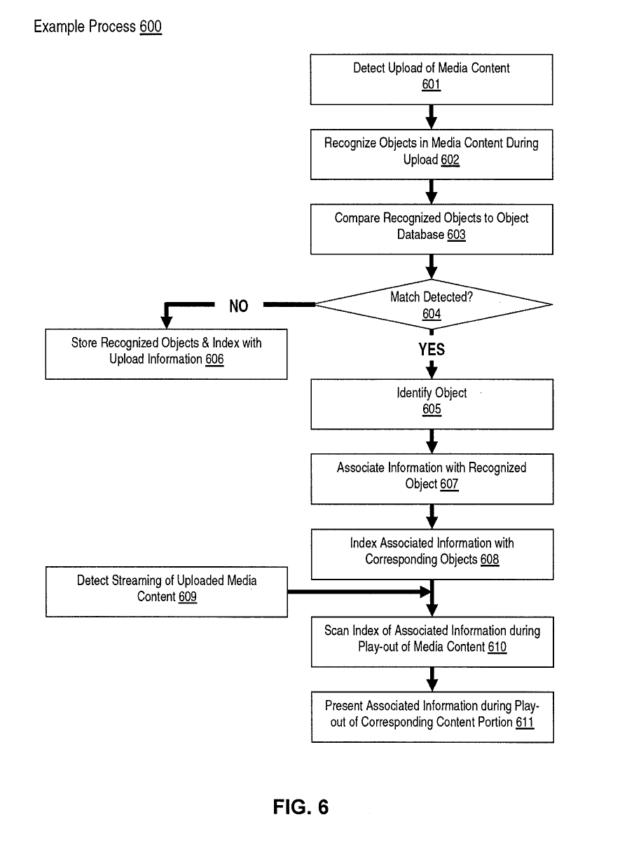

In step 101, an object is recognized within the media content portion, essentially in real time with respect to the presentation of the media content portion. The object may, for example, comprise a feature of a scene in the movie. The media content portion may have a particular temporal length (e.g., of a certain time duration, a given number of film or video frames, etc.). In implementations for example, a media content portion may comprise a six second long segment of a video, or a video clip that spans 30 frames at a given frame rate. In an embodiment, an object recognition step may alternatively or additionally execute at upload time (e.g., procedure 600; FIG. 6).

In step 102, information content is associated with the recognized object. The information content may be auxiliary or ancillary information that relates in some conceptual or commercial way with the recognized object. Auxiliary information may, for example, comprise an advertisement. The information content may be indexed to the recognized object, for instance, upon creation of the original media content of which the portion comprises a component. The information content may be stored in a repository such as a database, may include video, audio, textual, graphical, haptic or other content, and may include commercial, advertising, instructional, informative or other content associated with the recognized object. The term “auxiliary information” may be used herein to refer to information associated with a recognized object.

In step 103, a link is made to the associated information. Prior to associating the information with the recognized object and linking to the associated information, other functions may occur. For instance, the recognized object may be compared to a repository such as a database of stored objects, matched thereto and thus identified. Associating the information and linking thereto may be based on the comparison, match and corresponding identification of the object.

In step 104, information that is associated with the recognized object is presented therewith. For instance, the associated information may be presented essentially in real time with respect to the presentation of the media content portion in which the object appears as a feature thereof. The associated information may be presented in conjunction with the recognized object, for example, in a display field adjacent (or otherwise proximate) to a display field in which the media content portion is presented, or overlaid, superimposed, or inset with respect thereto. In an embodiment, object recognition may also function to block content. Thus media content that may be objectionable in some way may be censored in contexts where it may be appropriate to do so. For example, movies containing adult content may be blocked from access except to restricted audiences.

Thus for example, a hypothetical movie (e.g., media content) contains a scene (e.g., content portion) in which a star actor enters and drives a certain make and model sports car, or drinks from a particular brand of beverage. Auxiliary information may be associated with this scene that may include an advertisement for the certain make and model sports car or the beverage. As the scene plays, a link to the advertisement is provided. The media player, with which the scene is presented, thus links to the advertisement and presents the advertisement during the scene, in a display field proximate to the display field in which the scene is playing, or may superimpose the advertisement content over the scene, perhaps consciously apparent to a viewer or perhaps presented thereto subliminally.

In addition to advertisements, the auxiliary information associated with the media content may include other commercial information. For example, a hypothetical training video (e.g., media content) for engineers, mechanics, physicians, or technicians may include a segment (e.g., content portion in which a recognized object appears as a feature) in which an instructor, a teacher, professor or narrator demonstrates the function of a certain instrument, device, apparatus, component, chemical, solution, tool or the like, which may comprise a recognizable object. Auxiliary information may be associated with the object that may include commercial information related to the instrument, tool, etc.

Moreover, auxiliary information associated with the media content may include content that is informative in some manner or context with respect to the recognized object. Further, recognizable objects may include images of people, which appear as features in video scenes, such as the faces of actors, politicians or the like. Recognizable features may also include faces of such people with certain expressions, or posed with another recognizable object.

For example, a hypothetical movie (e.g., media content) may be a screen adaptation from a work of classic literature, such as William Shakespeare's Titus Andronicus or Johann Wolfgang von Goethe's Faust, or a movie or video that has achieved classic status or other special significance in cinematography, such as Gone with the Wind, Casablanca, or Apocalypse Now. An object that appears as a feature in a particular scene (e.g., content portion) of the movie may have some special literary or other artistic merit.

For example, the character Aaron's soliloquy, upon discovering his child in Titus Andronicus may be thought by literati to have special and perhaps enduring literary and dramatic (perhaps even spiritual) significance. During a presentation of a movie adaptation of Titus Andronicus in a hypothetical educational or literary setting, a scene is presented that includes a part of Aaron's famous soliloquy. Auxiliary information content may include a video, audio or text based commentary by a professor of literature, English or drama, or a theatrical critic or commentator that bears upon Aaron's soliloquy, and is thus associated with the scene being presented. Upon associating this auxiliary information with the scene based on a recognized object therein, Aaron's face for example, or Aaron's face with a particular expression enacted, and linking thereto, the commentary may be presented with the scene.

The association with and link to the associated auxiliary information may be made in real time with the presentation of the scene. The presentation of the auxiliary information may be made in real time and proximate to the media content portion, in which the recognized object appears as a feature, as well. To keep from distracting viewers and listeners of so acclaimed a soliloquy with the commentary related thereto however, real time presentation of the auxiliary content associated therewith may include simply a text or graphics based symbol that signifies the availability of the auxiliary information. The symbol that signifies the availability of the auxiliary information may allow the full commentary to be presented in real time, e.g., upon receiving an input. Alternatively, the presentation of the auxiliary content may be delayed and presented, e.g., after the scene is presented, or the scene may be viewed first with only a symbol that the commentary is available and then repeated with the commentary presented contemporaneously therewith. In an embodiment the auxiliary information content may not be presented or the presentation thereof may take another or an alternate form. For example, rather than present auxiliary content associated with an object recognized as a feature of a streaming video during play out a link with which a user may optionally access the auxiliary information content may be presented, such as with a graphical user interface (GUI).

Media content that have portions to which such informative auxiliary information may be associated are not limited to literary and other artistic works but may sound in virtually any field. For instance, media content may include recordings of scientific symposia, classroom lessons, political campaigns, speeches, debates, town hall meetings, legal and government proceedings, and the like. Auxiliary information that may be associated with recognized objects may thus include also include instructional, educational, aesthetic, contextual, and analytic information. Such auxiliary associated information may include commentary or criticism related to the object recognized as a feature of the media content portion. Alternative information may also be associated with the media content portion having certain recognized objects, for example, in the context of political campaigning. The recognized objects may include faces of prominent politicians or the like. Auxiliary information associated with such objects may relate to the media content may thus contrast with or contradict the media content portion, or include comparison thereto and augmentation and substantiation thereof.

Upon presenting the associated information with the recognized object, procedure 100 may continue (or restart) as another media content portion is presented or accessed. Alternatively, procedure 100 may be complete upon presenting the associated information with the recognized object.

The media content portion and its component parts portions may include original media content. A part of a media content portion may also include derivative content. Derivative content may be derived from the media content portion with an item of content that is independent with respect to the original instance of the media content. Derivative content may include a media sequence related to the original media content, such as an audio sample taken from a part of a song or a movie trailer taken from a scene of a video. Derivative content may be an authorized copy of original media content. For example, song samples and video trailers may be used to respectively advertise music and movies by an enterprise that owns the media and/or is engaged in marketing the media. However, embodiments of the present invention function even with derivative content that are not authorized, such as unauthorized copies of original content that are pirated. Thus, the auxiliary information is associated and linked to even from unauthorized copies of pirated media content portions.

Moreover, the media content and portions thereof may include content that is modified with respect to an original instance (e.g., version, etc.) of the media content. The media content may include content that has been scaled, edited, transcoded, scaled, converted, filtered, reformatted, distorted, or the like, or modified by combinations of such modifications.

### Example System

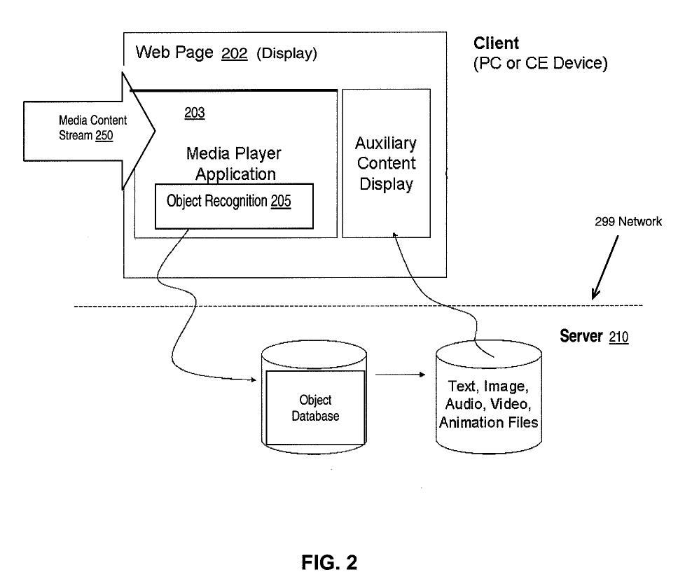

FIG. 2 depicts a first example system 200, according to an embodiment. System 200 functions in relation to associating information with media content using objects recognized therein. System 200 may thus execute a process, perform a procedure, or otherwise function to associate information with a portion of media content. In an embodiment, system 200 performs a procedure for associating information with a portion of media content such as procedure 100 (FIG. 1).

A portion of system 200 may be configured with one or more components of a computer system, which may operate under control of instructions that are encoded with computer readable storage media. A portion of system 200 may also be configured with an ASIC or a programmable IC device. Portions of system 200 may be disposed within a network capable media player or decoder and information repositories such as one or more databases. One or more repositories may be disposed integrally with, proximate to, or remote from other components of system 200, including the media player or decoder and/or another repository. Some components of system 200 may be coupled to other components thereof via one or more networks, which may include the Internet.

System 200 has a client computer 201. Client computer 201 may be a workstation, a personal computer (PC), or a consumer electronic (CE) device such as a TV, DVD player, stereo music system, home theater system or the like. Client 201 is communicatively coupled, directly or via one or more networks 299, with one or more servers 210. (Alternatively, one or more of servers 210 may be implemented with another client computer, e.g., another PC or CE device.) One or more of the servers 210 may be an Internet server. One or more of the servers 210 may be a database server. A stream 250 of media content is accessed (e.g., received, downloaded, or played back from a DVD, CD or other content recording) by client 201. Portions (e.g., six second segments) of the media content of stream 250 are decoded by a media player application 203. Media player application 203 presents the decoded portions on a web page or other presentation capable display 202. Media player application 203 may present the media content portions sequentially with respect to media content stream 250 as a whole, although their presentation may be disjoint with respect to the order with which some of the portions are decoded.

Media player application 201 has an embedded object recognition component 205. Object recognition component 205 may include software, hardware or combinations and functions to recognize objects within portions of media content stream 250. In an embodiment, objects may be recognized in media content stream 250 over each portion of the media content and in real time with respect to presentation or upload of that portion. In an implementation, object recognition component 205 functions with one or more computer vision related techniques, such as object recognition using local scale-invariant features.

Upon recognition in portions of stream 250, each of the recognized objects is compared to objects stored in a repository 211 thereof, such as an object database. In an embodiment, a function of object recognition component 205 may be performed with a server associated with the object repository, such as an object database server. Repository 211 may comprise a data storage component of client 201, a storage component that is proximate to or local with respect to client 201 and/or communicatively coupled thereto essentially directly, or a storage repository remote from client 201 and communicatively coupled therewith via one or more of networks 299.

Recognizing an object in a portion of media content stream 250 or with reference to an object stored in repository 211 allows identification of media content stream 250 and the portion thereof in which the object was recognized. The recognized object is indexed to information stored in a repository 212 such as a database of associated information content, including multiple audio, video, image, graphics, text, animation files, and combinations of multiple media files. Repository 212 may comprise a component of repository 211 or may be separate or independent therefrom and proximate to or local with respect to repository 211 or remote therefrom.

Repository 212 may be communicatively coupled essentially directly with repository 211 or communicatively coupled therewith via one or more of networks 299. With respect to one another, repositories 211 and 212 may comprise identical, similar, or different information storage types. Either or both of repositories 211 and 212 may comprise a database, a file system, a storage area network (SAN), network area storage (NAS) or network based virtual storage.

Upon indexing the object recognized in a portion of stream 250 and information content stored in repository 212, a match may be found. The matching auxiliary content 215 is associated with the portion of stream 250. Media player application 203 links to the associated auxiliary content 215. Media player application 203 presents the auxiliary content 215 in real time (or near real time) with respect to the presentation of the portion of stream 250 associated therewith. The associated (e.g., auxiliary) content 215 is displayed in proximity to (e.g., alongside, over, superimposed on) the corresponding portion of stream 250 in the video scene or a web page or other display 202.

### Example Information Repositories

Example embodiments may be implemented with a variety of information repositories, including databases, file systems and the like. Embodiments may be implemented for example with a database management system (DBMS). Embodiments of the present invention are not limited to any particular database or other repository architecture. The repository may store a body of records in one or more data containers. A data container may conform to tables in a relational database, a collection of objects (e.g., instances of object classes) in an object oriented database, or the like. The records within the body of records may conform to rows in a table, objects of an object class, or the like. The attributes of the records may conform to columns of the rows of a table, object attributes, or the like. For clarity, simplicity, unity, and brevity of description, example procedures may be described herein with reference to relational or object oriented databases. It should be appreciated however that embodiments are well suited to execution with any kind of database architecture (e.g., object oriented) or other information repository.

Example embodiments may be implemented with information that may be stored in one or more co-functional databases, each of which may function with one or more computers. Example embodiments may be implemented with a sharing of computational tasks over the multiple computers. Each of the multiple computers may be linked, or communicatively coupled, with one or more of the others via one or more data or telecommunication networks. Example embodiments may be implemented with a distributed database system. One or more of multiple database servers may be physically proximate to, or remote from, one or more of the other database servers.

Example embodiments may be implemented with mirrored databases or other information repositories. Example embodiments may be implemented with databases that include a primary and a logical or physical standby database. One or more mirror or standby databases may be physically proximate to, or remote from, one or more of the other (e.g., primary) databases.

Information is conveniently stored in repositories such as databases. Stored information is accessed and updated with applications executing in a database management system (DBMS). A DBMS functions both to efficiently store information in one or more containers and as a database server to efficiently retrieve the information therefrom, on request. Moreover, a DBMS functions to ensure that data retrieved therewith is fresh information and thus, to concomitantly deter retrieval of stale information. Each of the data containers of a database contains records. The data within each record is organized into one or more attribute fields. Various database architectures exist.

The data containers of relational databases are tables and the records stored therein are rows. Relational databases may contain virtually any number of tables, the attributes of which, are referred to as columns. The data containers of an object oriented database are object classes, the records of which comprise objects, which have attributes referred to as object attributes. Other database architectures also exist. Databases in general and relational databases more particularly are described herein for simplicity and unity, solely by way of example and illustration, and not for any limiting purpose. Information may be stored in one or more co-functional databases, each of which may function with one or more computers. Further, in processing large quantities of information, speed and/or efficiency may be promoted by sharing computational tasks over multiple computers. Each of the multiple computers is linked, or communicatively coupled, with one or more of the others via one or more networks. A database server that functions in such a networked, multi-computer, distributed computing environment, such as a computer cluster, may be referred to herein as a distributed database system. One or more of the multiple database servers may be physically proximate to, or remote from, one or more of the other database servers.

Databases and other information repositories may be mirrored. For example, a first instance of information content may be stored with a first database and a second instance of essentially the same content may be stored at a second database. The second instance of content may substantially duplicate the first instance thereof. The second repository thus mirrors the first repository. Moreover, one database may function to back up data that is stored in another database. For example, a third database ‘A’ may function as a standby database for a primary or production database ‘B’. The standby database ‘A’ may store a physical instance or a logical instance of information stored in the primary database ‘B’. One or more mirror or standby databases may be physically proximate to, or remote from, one or more of the other (e.g., primary) databases.

To retrieve data stored in a database, queries are submitted to a database server, which computes the query and returns the data requested therewith. Query statements submitted to a database server typically conform to syntax characteristic of a particular database language with which the DBMS functions. SQL (Structured Query Language) and PL/SQL (Procedural Language/SQL) are well known examples of such languages. Other database languages, some of them proprietary, may also be also used.

### Example Procedures

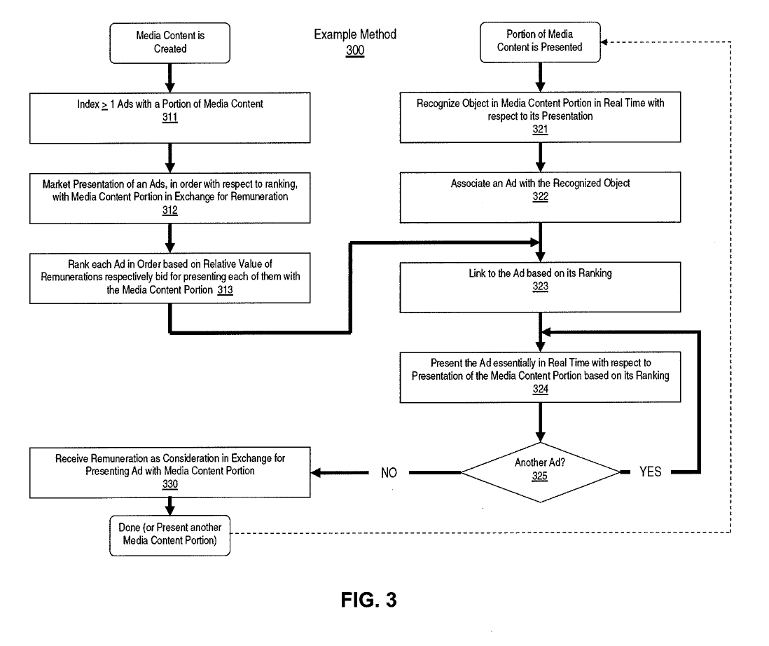

Procedures and systems described herein may be used for conducting business operations such as may relate to sales and presentation of advertising and instruction and the presentation of commercial and educational information. FIG. 3 depicts a flowchart for an example procedure 300, according to an embodiment of the present invention. Upon creation of media content, one or more advertisements (“Ads”) are indexed in step 311 with a portion thereof.

In step 312, presentation of the advertisements in exchange for valuable consideration such as remuneration, revenue or the like, is marketed with the media content portion. For example, the advertisements may be marketed to entities that may want to associate an advertisement related to their product or service, with the media content portion or objects recognized as features therein. Where more than one advertisement is associated with a single recognized object, each of the advertisements may be ranked in an order.

In step 313 therefore, each of the advertisements is ranked in an order that is based on the relative values of the remuneration, which were respectively offered (e.g., bid) for presenting them with the media content portion in which the recognized object appears. For example, a first price value is greater than a second price value. A first advertisement from a first entity, which bids the first price value for associating the first advertisement with the recognized object, is ranked higher in the order than a second advertisement from a second entity, which bid the lower second price value for associating the second advertisement with the recognized object.

Upon presentation or upload of the media content portion, an object is recognized in the media content portion in step 321. The object is recognized in real time with respect to the presentation (or upload) of the corresponding media content portion. In step 322, one or more advertisements are associated with the recognized object, based for example on an identity associated with or corresponding to the object.

In step 323, a link is made to one or more of the advertisements, based on their respective rankings. In step 324, the advertisement to which a link is established is presented essentially in real time with respect to the presentation of the media content portion in which the recognized object appears as a feature.

In step 325, it is determined whether another advertisement is associated with the recognized object. If so, step 324 is repeated for the other advertisement. Other advertisements may be selectively or sequentially displayed with the media content portion in which the recognized object appears as a feature, based on their respective rankings.

If no other advertisements are associated with the recognized object, or upon presentation of all or a given number of the other advertisements associated therewith, remuneration is received in step 330, e.g., upon notification, billing, debiting, invoicing or the like of the entities that have agreed to have their advertisements presented with the media content. Procedure 300 may now be complete or may repeat upon presentation of another media content portion in which a recognized object appears as a feature.

Other procedures may relate to providing instruction, education, or training, providing a forum for commentary, or providing commercial information in exchange for remuneration. In such procedures, instructional, educational, or technical information, commentary, concurrence, debate and dissent, and commercial information are respectively associated with media content. Upon presentation of a certain media content portion in which a recognized object appears as a feature, a particular item of the associated (e.g., auxiliary) information is provided and remuneration is received in exchange therefore.

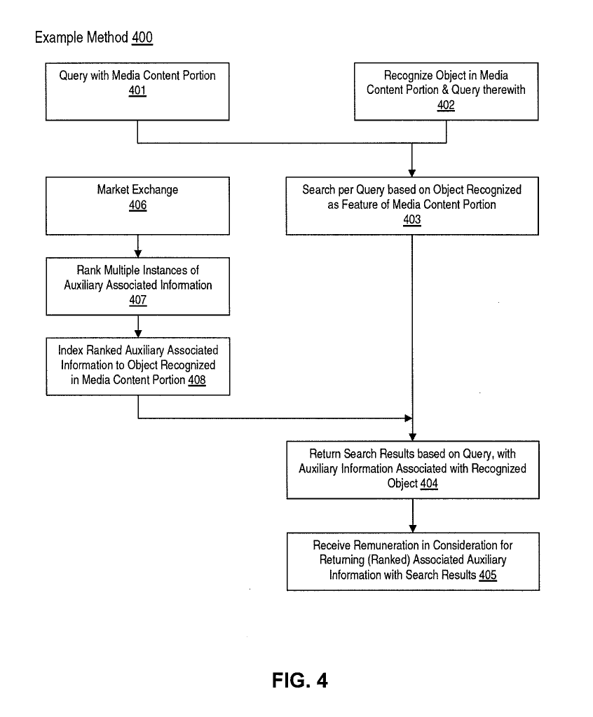

FIG. 4 depicts a flowchart for another example procedure 400, according to an embodiment of the present invention. In step 401, an object recognized in media content or a portion thereof comprises a query input to a search engine. Querying with an object recognized in media content may conserve bandwidth, e.g., in comparison to using raw media content or a portion thereof, as a query input. In step 403, a search engine performs a search for information relating to the recognized object or the media content or portion thereof in which the object was recognized. The search may be performed across multiple information repositories such as databases or a virtual database comprising the contents of the Internet. In step 404, auxiliary information associated with the recognized object may be presented with the search results returned in response to the query.

Either of these embodiments may be used for searching libraries, databases, or other repositories of media content for particular media segments or other portions of media content. Upon returning search results in response to queries, auxiliary information that is associated with the recognized object is presented with the search results.

Moreover, another procedure may be related to procedure 400. For instance, in step 405, valuable consideration is received in exchange for returning the auxiliary associated information with the search results. The exchange may be marketed in step 406. Multiple instances of auxiliary associated information may exist. In step 407, the multiple instances may be ranked. In an embodiment, the ranking may be based on the value of remuneration agreed to in exchange for linking to and/or providing the auxiliary information with the search results. In step 408, the ranked auxiliary associated information may be indexed to the recognized object and/or search results.

### Example Computer System Platform

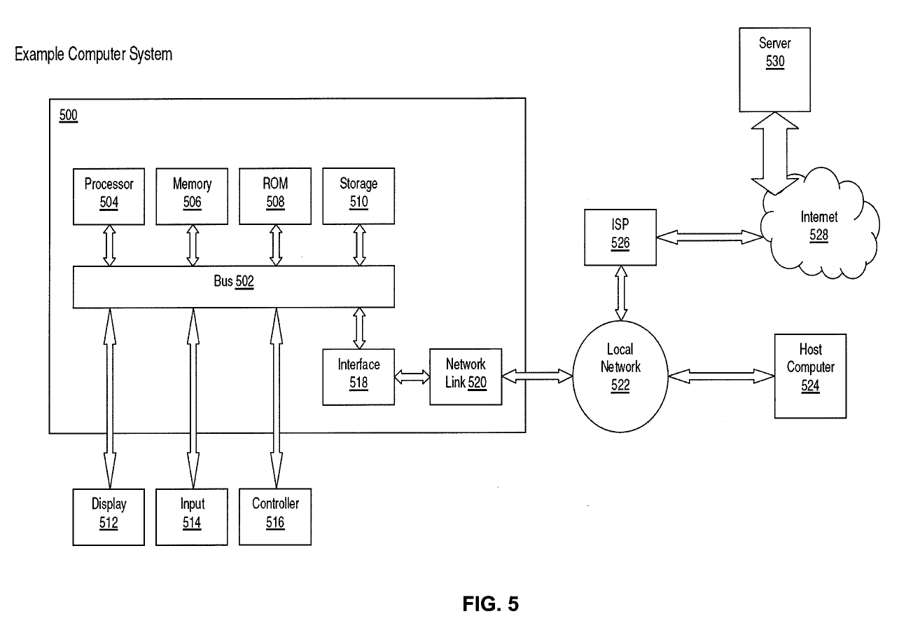

FIG. 5 depicts an example computer system platform 500, with which an embodiment may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), cathode ray tube (CRT) or the like, for displaying information to a computer user. An input device 514, including alphanumeric keys (or keys that relate to other than a Latin-based alphabet or Arabic-based numerals) and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Embodiments relate to the use of computer system 500 in relation to associating information with media content using objects recognized therein. According to an embodiment, object recognition within media content or associating information therewith is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein may refer to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and other conductors and fiber optics, including the wires that comprise bus 502. Transmission media can also take the form of acoustic or electromagnetic waves, such as those generated during radio and infrared or other optical data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes or contrasting darkenings, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a digital subscriber line (DSL), cable or other modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for associating information with media content, as described herein.

The received code may be executed by processor 504 as it is received, and/or stored in storage device 510, or other non-volatile storage for later execution. In this manner, computer system 500 may obtain application code in the form of a carrier wave.

### Example Procedure

Media such as video and audio content may be readily accessed from various sources, which include websites and web services. Moreover, various entities operate and maintain websites that allow individuals to upload and store media content, which is then accessible to others. For instance, YouTube allows individuals to upload media content which is indexed and stored and made available for streaming to individuals who may desire to access the content.

FIG. 6 depicts a flowchart for an example procedure 600, according to an embodiment of the present invention. In step 601, uploading of media content is detected by a media entity that receives media uploads, stores and indexes the uploaded media content, and makes the media content available for streaming. In step 602, objects are recognized in the media content at upload time, e.g., as the content is uploaded to the entity. Objects may be recognized as features of media content at upload time or at any time following upload and before presentation (e.g., run out) time. As each portion of the media content uploads, objects are recognized in real time from each portion.

In step 603, the recognized objects are compared to a repository of stored objects such as a database. The objects may be compared to the database in real time with respect to their recognition in their respective content portions with essentially no intentional delay upon successful uploading of each portion. In an embodiment, a recognized object may be identified by such comparison. In step 604, it is determined whether a match is detected between the recognized objects and the databased objects. If a match is detected, then in step 605, the uploading media content may be identified based at least in part on an object recognized therein. Each portion of the media content may be individually identified as objects that correspond to each portion are recognized therein. Object recognition may be performed over the entire course of uploading the content.

In step 606, if no match is detected, recognized objects may optionally be stored and indexed with information that relates to the upload, e.g., for subsequent analysis and/or identification. Alternatively, recognized objects for which no match is found may be deleted, overwritten, or the like.

In step 607, upon recognizing an object in a media content portion, information may be associated with the recognized object. The information may be auxiliary information such as an advertisement, educational material or the like. In step 608, the information associated with the recognized object is indexed thereto. In an embodiment, metadata may be created, which characterize the uploaded media file in terms of the associated information content that may correspond to each portion thereof. The metadata are stored in an information file that is associated with the content. Importantly, indexing the information associated with the content portions may identify exact times within the content, e.g., throughout its entire runtime, at which auxiliary content or other information is associated with an object recognized as a feature in the uploaded multimedia content.

For example, the media content may comprise a movie that is uploaded to an entity such as YouTube. The information file is created by the upload entity and associated with the example movie and assigned an identifier such as a filename. Entries within the information file include a first column (or other data format) that contains timestamps from time ‘zero’ (0) to a time ‘movie length’ that corresponds to the duration of the movie. The timestamps thus function to delineate individual content portions. These timestamps index a second column (or other data format), which contain references to the associated information that may correspond to objects recognized in the content portion (e.g., movie interval) delineated with the timestamps of the first column.

After content is uploaded, the upload entity may make the content available for streaming. In step 609, streaming of the uploaded media content is detected. In step 610, the index of information associated with the content is scanned in parallel with play-out of the content. In step 611, the associated information is presented during play-out of the content portions to which they correspond. As the content is streamed, its file of stored information is scanned. As each content portion is reached, timestamps stored in the first column of the file index the second column to identify the appropriate corresponding information associated with recognized objects that appear as features in that portion. The entity then displays the associated information, as directed by the file entries in the second column. For example, an appropriate advertisement, educational comment or the like, which corresponds to a certain recognized object in a media content portion may be presented in real time with the content portion.

Fees may be charged for displaying advertisements with the appropriate content portions. Advertisements may be selected from among several candidates based on a ranking that may involve fees charged for different advertising rates. Similarly, educational material or the like may be displayed as auxiliary information content, in association with particular objects, recognized as features in media content portions.

Recognizing objects as features of media content upon upload (e.g., at upload time or after upload but prior to play-out time) allows association of information such as presentation of auxiliary information with the recognized objects prior to play-out time. This may deter gaps or latency in association of information with media content. In as much as gaps or latency in associating information with media content may correspond to missed opportunities for presentation of auxiliary information therewith, deterring formation of such gaps can increase advertising revenues or educational efficiency.

### Example System

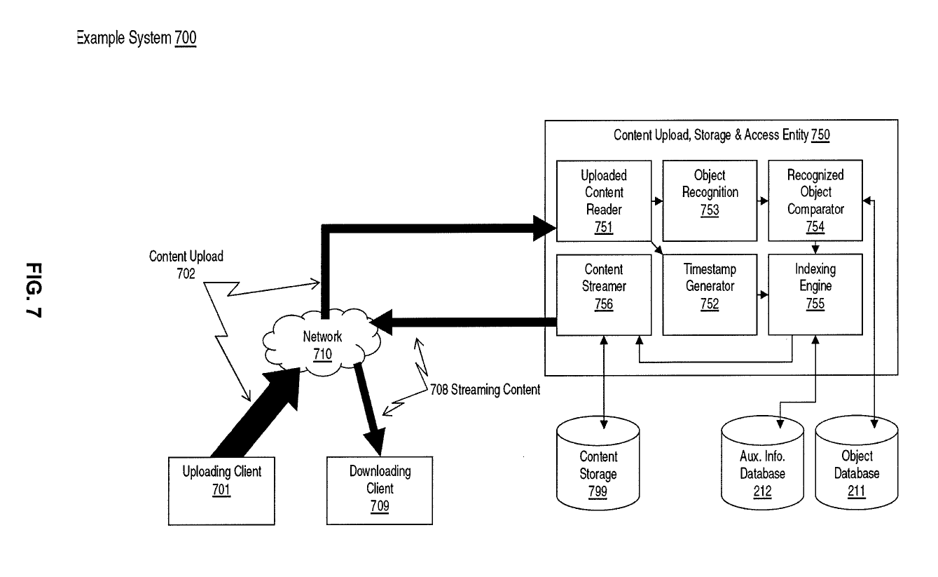

FIG. 7 depicts a second example system 700, according to an embodiment. System 700 may use or comprise one or more components of at least one computer system, such as computer platform 500 (FIG. 5), described above. System 700 is well suited for executing procedures relating to associating information with media content using objects recognized therein, such as procedure 600 (FIG. 6) above, in which objects are recognized in media content upon upload (e.g., at upload time or after upload but prior to play-out time).

System 700 may be effectuated by a content upload, storage and access entity 750. Entity 750 functions to allow uploading of media content, storing the uploaded content and providing access thereto such as by streaming. Entity 750 may be thought of as representative of functions that are used or performed by network based systems such as may be deployed, operated or maintained any of a variety of enterprises. Such enterprises may include businesses and educational, governmental and social institutions. The enterprises may engage in providing information such as auxiliary content in association with media content as a service, which may be operated as a profit or revenue generating function thereof.

For instance, YouTube™, Google Images™, ITunes™, and other, in a functional sense, substantially or somewhat similar web based businesses may allow users to upload media content for storage and access by others. They may, in fact, function to provide the upload, storage and streaming service features available to client computer users at a low or very low cost; perhaps even gratuitously. Upon the stored content being accessed, entity 750 may further function to provide auxiliary content linked to certain recognized objects and displayed essentially in real time with respect therewith. The media content may, for example, comprise a movie and the auxiliary content may include advertisements, critical or educational commentary or the like. Each unit of auxiliary content may correspond, e.g., temporally as well as subjectively or contextually, to certain portions of the media content. Upon presentation of the auxiliary information, a business entity may assess a fee. Fees may be based on a per instance of advertisement presentation for example, or they may include tuition paid for an on line course that presents timely educational information in real time with respect to the appropriate content portions in which the recognized objects appear as features. In an embodiment, functions of one or more components described herein with respect to entity 750 may be subsumed in the function of another.

Entity 750 is communicatively coupled with data communications network 710. Network 710 may include one or more networks, which may include the Internet. Client computers 701 and 709 are also communicatively coupled with network 710. Client 701 uploads content 702 to entity 750 via network 710. Entity 750 streams content 708 to client 709.

Upon receiving content upload 702, the content is processed with uploaded content reader 751. Upon upload (e.g., at upload time or after upload but prior to play-out time), object recognition component 753 recognizes objects within processed content. Object recognition component 753 may perform one or more functions associated with object recognition component 205 (FIG. 2). Object comparator 754 compares the recognized objects against those stored in object database 711 and, on the basis of matches detected between the recognized objects and databased objects, may also function to identify the uploaded content.

Indexing engine 755 formats a data configuration such as a file, which identifiably corresponds to the media content. For example, index engine 755 may open a file and assign a file name to the identified uploaded media content. Index engine 755 writes information such as metadata to the file, which is descriptive of the media content. The metadata include temporal data such as timestamps, with which individual component portions of the media content may be identified or described. In an embodiment, timestamp generator 752 writes portion descriptive temporal metadata to a column of the media content file.

Index engine 755 correlates each recognized object with associated information stored in auxiliary information (“aux. info.”) database 712. For example, index engine 755 may index metadata, descriptive of stored units of auxiliary information and stored in an associated information column of the content file, to the timestamps that are written in the temporal metadata column, which correspond to the individual content portions in which objects are recognized as features.

Content storage 799 stores uploaded (and pre-stored) media content. Content storage 799, auxiliary information database 712 and/or object database 711 may comprise functions of a single or multiple storage repositories. Alternatively, the repositories may be physically or logically disposed in multiple databases, which may be networked, mirrored, clustered and/or redundant, and may include SAN or NAS components. The repositories may be components of entity 750, or they may be communicatively coupled therewith and disposed proximate thereto or remote therefrom. Functions of one or more of databases 711 and 712 may respectively substantially duplicate, mimic, minor or represent analogous functions that may be performed by databases 211 and 212 (FIG. 2).

Upon a request from client 709, entity 750 streams previously uploaded (or pre-stored) content 708 to client 709 via network 710. Content streamer 756 streamer retrieves the content from content storage 799. Content streamer 799 functions with indexing engine 755 to identify the data file that corresponds to the requested content with its filename. While streaming content 708, content streamer 756 scans the data file. Content streamer 756 functions with indexing engine 755 to retrieve instances of associated information from auxiliary information database 212 with the portions of media content to which they correspond. The associated information is thus provided in real time with the media content portions in which an indexed recognized object appears as a feature.

### Enumerated Example Embodiments

Some embodiments of the present invention may thus relate to one or more of the examples that are enumerated below

1. A method, comprising the steps of:

recognizing at least one object within a portion of media content

wherein the object comprises a feature of the media content portion; and

associating information with the object upon recognizing the object.

2. The method as recited in Enumerated Example Embodiment 1 wherein the recognizing step is performed during one or more of play out or upload of the media content portion.

3. The method as recited in Enumerated Example Embodiment 1 wherein the associating step comprises the steps of:

identifying the recognized object; and

mapping the associated information to the identified object.

4. The method as recited in Enumerated Example Embodiment 3 wherein the associating step further comprises the step of:

providing the associated information with the media content portion.

5. The method as recited in Enumerated Example Embodiment 4 wherein the mapping step comprises the steps of:

querying an information repository in relation to the identified object;

wherein the information repository comprises:
a catalog of a first plurality of identified objects, each arranged in relation an identity thereof; and
an index of the catalog, which relates one or more of the first plurality of identified objects in relation to a second plurality of information sources; and

wherein the second plurality of information sources comprises a source of the associated information; and

in response to the query, indexing the associated information to the identified object.

6. The method as recited in Enumerated Example Embodiment 5 wherein the providing step comprises the step of:

linking to the indexed information.

7. The method as recited in Enumerated Example Embodiment 4 wherein the providing step comprises the step of:

presenting the associated information in at least one of real time or near real time in relation to the media content portion.

8. The method as recited in Enumerated Example Embodiment 1 wherein the media content comprises at least one of video or image related media content.

9. The method as recited in Enumerated Example Embodiment 1 wherein the media content comprises one or more of:

a) an essentially original instance of the media content;

b) an instance of content that conforms substantially to an original instance of the media content; or

c) an instance of content that is derived from one or more of the a) instance or the b) instance.

10. The method as recited in Enumerated Example Embodiment 9 wherein the derivative content instance c) comprises one or more of:

d) a content instance that conforms substantially to one or more of the content instances a) and b); or

e) a content instance that is modified in relation to one or more of the content instances a) or b).

11. The method as recited in Enumerated Example Embodiment 10 wherein the content instance e) is modified in relation to one or more of the content instances a) or b) with respect to one or more of editing, scaling, transcoding, or distortion.

12. The method as recited in Enumerated Example Embodiment 1 wherein the associated information comprises at least one of video, audio, textual, graphical, or haptic based content.

13. The method as recited in Enumerated Example Embodiment 1 wherein the associated information relates to an advertisement.

14. The method as recited in Enumerated Example Embodiment 1 wherein the associated information comprises at least one of commercial information and instructional information; and

wherein the instructional comprises one or more of educational information, aesthetic information, contextual information, analytic information, commentary, or criticism, which relates to the recognized object, or alternative information that relates to the recognized object with at least one of contrast, comparison, augmentation, substantiation, or contradiction.

15. The method as recited in Enumerated Example Embodiment 13 or Enumerated Example Embodiment 14, further comprising the steps of:

providing the associated content; and

in an exchange for the providing step, receiving consideration in remuneration.

16. A method, comprising the steps of:

recognizing at least one object within a portion of media content

wherein the object comprises a feature of the media content portion;

associating an advertisement with the recognized object, based on the recognizing step; and

in an exchange for the associating step, receiving consideration in a remuneration.

17. The method as recited in Enumerated Example Embodiment 15, further comprising the step of:

marketing the exchange.

18. The method as recited in Enumerated Example Embodiment 15 wherein the advertisement comprises a plurality of independent instances of advertising content, the method further comprising the step of

ranking the independent instances of advertising content within the plurality thereof;

wherein the linking to the associating an advertisement step comprises selectively linking to one or more of the independent instances of advertising content based on the ranking step; and

wherein the ranking step is based, at least in part, on a value associated with the remuneration.

19. The method as recited in Enumerated Example Embodiment 18 wherein the value associated with the remuneration relates to at least one of a financial or a monetary value corresponding to the remuneration.

20. The method as recited in Enumerated Example Embodiment 15 wherein the recognizing step is performed during one or more of play out or upload of the media content portion.

21. The method as recited in Enumerated Example Embodiment 15 wherein the associating step comprises the steps of:

identifying the recognized object; and

mapping the associated information to the identified object.

22. The method as recited in Enumerated Example Embodiment 21 wherein the associating step further comprises the step of:

providing the associated information with the media content portion.

23. The method as recited in Enumerated Example Embodiment 22 wherein the providing step comprises the step of:

presenting the advertisement in at least one of real time or near real time in relation to the media content portion.

24. The method as recited in Enumerated Example Embodiment 15 wherein the media content comprises one or more of:

a) an essentially original instance of the media content;

b) an instance of content that conforms substantially to an original instance of the media content; or

c) an instance of content that is derived from one or more of the a) instance or the b) instance.

25. The method as recited in Enumerated Example Embodiment 24 wherein the derivative content instance c) comprises one or more of:

d) a content instance that conforms substantially to one or more of the content instances a) and b); or

e) a content instance that is modified in relation to one or more of the content instances a) or b).

26. The method as recited in Enumerated Example Embodiment 25 wherein the content instance e) is modified in relation to one or more of the content instances a) or b) with respect to one or more of editing, scaling, transcoding, or distortion.

27. A method, comprising the steps of:

recognizing at least one object within a portion of media content

wherein the object comprises a feature of the media content portion;

upon recognizing the object, associating at least one of commercial information or instructional information with at least one of the recognized object, or the media content; and

in an exchange for the associating step, receiving consideration in a remuneration;

wherein the instructional information comprises one or more of educational information, aesthetic information, contextual information, analytic information, commentary, or criticism, which relates to the recognized object, or alternative information that relates to the recognized object with at least one of contrast, comparison, augmentation, substantiation, or contradiction.

28. The method as recited in Enumerated Example Embodiment 27, further comprising the step of: marketing the exchange.

29. A computer readable storage medium comprising encoded instructions which, when executing over one or more processors of a computer, controls the computer to perform a method, which comprises the steps of:

recognizing at least one object within a portion of media content

wherein the object comprises a feature of the media content portion; and

associating information with the object upon recognizing the object.

30. A system, comprising:

means for recognizing at least one object within a portion of media content

wherein the object comprises a feature of the media content portion; and

means for associating information with the object upon recognizing the object.

31. A system, comprising:

at least one processor; and

a computer readable storage medium that comprises encoded instructions which, when executing over the at least one processor, controls the system to perform a method, which comprises the steps of:

recognizing at least one object within a portion of media content;

wherein the object comprises a feature of the media content portion; and

associating information with the object upon recognizing the object.

32. A computer readable storage medium comprising encoded instructions which, when executing over one or more processors of a computer, controls the computer to perform a method, which comprises the steps of:

recognizing at least one object within a portion of media content

wherein the object comprises a feature of the media content portion;

associating an advertisement with the recognized object upon recognizing the object; and

in an exchange for the associating step, receiving consideration in a remuneration.

33. The computer readable storage medium as recited in Enumerated Example Embodiment 32, wherein the method further comprises the step of:

marketing the exchange.

34. The computer readable storage medium as recited in Enumerated Example Embodiment 33 wherein the advertisement comprises a plurality of independent instances of advertising content; and

wherein the method further comprises the step of:

ranking the independent instances of advertising content within the plurality thereof;

wherein the linking to the associating an advertisement step comprises selectively linking to one or more of the independent instances of advertising content based on the ranking step; and

wherein the ranking step is based, at least in part, on a value associated with the remuneration.

35. The computer readable storage medium as recited in Enumerated Example Embodiment 34 wherein the value associated with the remuneration relates to at least one of a financial or a monetary value corresponding to the remuneration.

36. The computer readable storage medium as recited in Enumerated Example Embodiment 32 wherein the recognizing step is performed during one or more of play out or upload of the media content portion.

37. The computer readable storage medium as recited in Enumerated Example Embodiment 32 wherein the associating step comprises the steps of:

identifying the recognized object; and

mapping the associated information to the identified object.

38. The computer readable storage medium as recited in Enumerated Example Embodiment 37 wherein the associating step further comprises the step of:

providing the associated information with the media content portion.

39. The computer readable storage medium as recited in Enumerated Example Embodiment 38 wherein the providing step comprises the step of:

presenting the advertisement in at least one of real time or near real time in relation to the media content portion.

40. A computer readable storage medium, comprising encoded instructions which, when executing over one or more processors of a computer, controls the computer to perform a method, which comprises the steps of:

recognizing at least one object within a portion of media content

wherein the object comprises a feature of the media content portion;

upon recognizing the object, associating at least one of commercial information or instructional information with the recognized object; and

in an exchange for the associating step, receiving consideration in a remuneration;

wherein the instructional information comprises one or more of educational information, aesthetic information, contextual information, analytic information, commentary, or criticism, which relates to the recognized object, or alternative information that relates to the recognized object with at least one of contrast, comparison, augmentation, substantiation, or contradiction.

41. The computer readable storage medium as recited in Enumerated Example Embodiment 34, wherein the method further comprises the step of:

marketing the exchange.

42. A system, comprising:

means for recognizing at least one object within a portion of media content

wherein the object comprises a feature of the media content portion;

means for associating an advertisement with the recognized object upon recognizing the object; and

means for receiving consideration in a remuneration in an exchange for executing a function of the associating means.

43. The system as recited in Enumerated Example Embodiment 42, further comprising:

means for marketing the exchange.

44. The system as recited in Enumerated Example Embodiment 43 wherein the advertisement comprises a plurality of independent instances of advertising content; and

wherein the system further comprises:

means for ranking the independent instances of advertising content within the plurality thereof;

wherein the associating means comprises means for selectively linking to one or more of the independent instances of advertising content based on a function of the ranking means; and

wherein the ranking means perform a function that is based, at least in part, on a value associated with the remuneration.

45. The system as recited in Enumerated Example Embodiment 44 wherein the value associated with the remuneration relates to at least one of a financial or a monetary value corresponding to the remuneration.

46. The system as recited in Enumerated Example Embodiment 42 wherein a function of the recognizing means is performed during one or more of play out or upload of the media content portion.

47. The system as recited in Enumerated Example Embodiment 42 wherein the associating means comprises:

means for identifying the recognized object; and

means for mapping the associated information to the identified object.

48. The system as recited in Enumerated Example Embodiment 47 wherein the associating means further comprises:

means for providing the associated information with the media content portion.

49. The system as recited in Enumerated Example Embodiment 48 wherein the providing means comprises:

means for presenting the advertisement in at least one of real time or near real time in relation to the media content portion.

50. The system as recited in Enumerated Example Embodiment 42 wherein the media content comprises one or more of:

a) an essentially original instance of the media content;

b) an instance of content that conforms substantially to an original instance of the media content; or

c) an instance of content that is derived from one or more of the a) instance or the b) instance.

51. The system as recited in Enumerated Example Embodiment 50 wherein the derivative content instance c) comprises one or more of:

d) a content instance that conforms substantially to one or more of the content instances a) and b); or

e) a content instance that is modified in relation to one or more of the content instances a) or b).

52. The method as recited in Enumerated Example Embodiment 51 wherein the content instance e) is modified in relation to one or more of the content instances a) or b) with respect to one or more of editing, scaling, transcoding, or distortion.

53. A system, comprising:

means for recognizing at least one object within a portion of media content

wherein the object comprises a feature of the media content portion;

means for associating at least one of commercial information or instructional information with the recognized object upon recognizing the object; and

means for receiving consideration in a remuneration in an exchange for performing a function of the associating means;

wherein the instructional information comprises one or more of educational information, aesthetic information, contextual information, analytic information, commentary, or criticism, which relates to the recognized object, or alternative information that relates to the recognized object with at least one of contrast, comparison, augmentation, substantiation, or contradiction.

54. The system as recited in Enumerated Example Embodiment 53, further comprising:

means for marketing the exchange

55. A computer readable storage medium comprising encoded instructions which, when executing over one or more processors of a computer, controls the computer to configure a system as recited in any of Enumerated Example Embodiments 42-54.

56. A method, comprising the steps of:

querying an information repository for information that relates to a portion of media content;

wherein the query executes in relation to an object, which comprises a feature of the media content portion; and

returning a search result related to the recognized object;

wherein the returning step comprises the steps of:
recognizing the object;
indexing auxiliary information that is associated with the recognized object; and

providing the auxiliary information;

wherein the auxiliary information is presented with the search result.

57. The method as recited in Enumerated Example Embodiment 56, further comprising:

in an exchange for returning the auxiliary information with the search result, receiving consideration in a remuneration.

58. The method as recited in Enumerated Example Embodiment 57, further comprising the step of:

marketing the exchange.

59. The method as recited in Enumerated Example Embodiment 58 wherein the auxiliary information comprises a plurality of independent instances of information associated with the recognized object, the method further comprising the step of:

ranking the independent instances of associated information within the plurality thereof;

wherein the returning step comprises selectively providing one or more of the independent instances of associated information based on the ranking step; and

wherein the ranking step is based, at least in part, on a value associated with the remuneration.

60. The method as recited in Enumerated Example Embodiment 59 wherein the value associated with the remuneration relates to at least one of a financial or a monetary value corresponding to the remuneration.

61. The method as recited in Enumerated Example Embodiment 56 wherein the media content comprises one or more of:

a) an essentially original instance of the media content;

b) an instance of content that conforms substantially to an original instance of the media content; or

c) an instance of content that is derived from one or more of the a) instance or the b) instance.

62. The method as recited in Enumerated Example Embodiment 61 wherein the derivative content instance c) comprises one or more of:

d) a content instance that conforms substantially to one or more of the content instances a) and b); or

e) a content instance that is modified in relation to one or more of the content instances a) or b).

63. The method as recited in Enumerated Example Embodiment 62 wherein the content instance e) is modified in relation to one or more of the content instances a) or b) with respect to one or more of editing, scaling, transcoding, or distortion.

64. A computer readable storage medium comprising encoded instructions which, when executing over one or more processors of a computer, controls the computer to perform a method, which comprises the steps of:

querying an information repository for information that relates to a portion of media content;

wherein the query executes in relation to an object, which comprises a feature of the media content portion; and

returning a search result related to the object;

wherein the returning step comprises the steps of:
recognizing the object;
indexing auxiliary information that is associated with the recognized object; and
providing the auxiliary information;

wherein the auxiliary information is presented with the search result.

65. The computer readable storage medium as recited in Enumerated Example Embodiment 64 wherein the method further comprises the step of:

in an exchange for returning the auxiliary information with the search result, receiving consideration in a remuneration.

66. The computer readable storage medium as recited in Enumerated Example Embodiment 65 wherein the method further comprises the step of:

marketing the exchange.

67. The computer readable storage medium as recited in Enumerated Example Embodiment 66 wherein the auxiliary information comprises a plurality of independent instances of information associated with the recognized object, the method further comprising the step of:

ranking the independent instances of associated information within the plurality thereof;

wherein the returning step comprises selectively providing one or more of the independent instances of associated information based on the ranking step; and

wherein the ranking step is based, at least in part, on a value associated with the remuneration.

68. The computer readable storage medium as recited in Enumerated Example Embodiment 67 wherein the value associated with the remuneration relates to at least one of a financial or a monetary value corresponding to the remuneration.

69. The computer readable storage medium as recited in Enumerated Example Embodiment 64 wherein the media content comprises one or more of:

a) an essentially original instance of the media content;

b) an instance of content that conforms substantially to an original instance of the media content; or

c) an instance of content that is derived from one or more of the a) instance or the b) instance.

70. The computer readable storage medium as recited in Enumerated Example Embodiment 69 wherein the derivative content instance c) comprises one or more of:

d) a content instance that conforms substantially to one or more of the content instances a) and b); or

e) a content instance that is modified in relation to one or more of the content instances a) or b).

71. The method as recited in Enumerated Example Embodiment 70 wherein the content instance e) is modified in relation to one or more of the content instances a) or b) with respect to one or more of editing, scaling, transcoding, or distortion.

72. A system, comprising:

means for querying an information repository for information that relates to a portion of media content;

wherein the query executes in relation to an object, which comprises a feature of the media content portion; and

means for returning a search result related to the object;

wherein the returning means comprises:
means for recognizing the object;
means for indexing auxiliary information that is associated with the recognized object; and
means for providing the auxiliary information;

wherein the auxiliary information is presented with the search result.

73. The system as recited in Enumerated Example Embodiment 72, further comprising:

means for receiving consideration in a remuneration in an exchange for returning the associated information with the search result.

74. The system as recited in Enumerated Example Embodiment 73 wherein the method further comprises the step of:

means for marketing the exchange.

75. The system as recited in Enumerated Example Embodiment 74 wherein the auxiliary information comprises a plurality of independent instances of information associated with the recognized object, the system further comprising:

means for ranking the independent instances of associated information within the plurality thereof;

wherein the returning means comprises means for selectively providing one or more of the independent instances of associated information based on a function of the ranking means; and

wherein the ranking means perform a function that is based, at least in part, on a value associated with the remuneration.

76. The system as recited in Enumerated Example Embodiment 75 wherein the value associated with the remuneration relates to at least one of a financial or a monetary value corresponding to the remuneration.

77. The system as recited in Enumerated Example Embodiment 72 wherein the media content comprises one or more of:

a) an essentially original instance of the media content;

b) an instance of content that conforms substantially to an original instance of the media content; or

c) an instance of content that is derived from one or more of the a) instance or the b) instance.

78. The system as recited in Enumerated Example Embodiment 77 wherein the derivative content instance c) comprises one or more of:

d) a content instance that conforms substantially to one or more of the content instances a) and b); or

e) a content instance that is modified in relation to one or more of the content instances a) or b).

79. The system as recited in Enumerated Example Embodiment 78 wherein the content instance e) is modified in relation to one or more of the content instances a) or b) with respect to one or more of editing, scaling, transcoding, or distortion.

80. A computer readable storage medium comprising encoded instructions which, when executing over one or more processors of a computer, controls the computer to configure a system as recited in any of Enumerated Example Embodiments 72-79.

### Equivalents, Extensions, Alternatives and Miscellaneous

Example embodiments relating to associating information with media content using objects recognized therein are thus described. In the foregoing specification, embodiments of the present invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising the steps of:
recognizing at least one object within a portion of media content during one or more of play out or upload of the media content portion;
wherein the object comprises a feature of the media content portion;
associating a plurality of associated information with the object upon recognizing the object; and
ranking each of the plurality of associated information based on relative values of remuneration which were respectively offered for presenting the associated information with the media content portion in which the recognized object appears;
wherein the associating step comprises the steps of:
identifying the recognized object;
mapping the associated information to the identified object; and
providing the associated information with the media content portion; and
wherein the providing step comprises linking to one or more of the plurality of associated information instances based, at least in part, on the ranking step.

2. The method as recited in claim 1 wherein the mapping step comprises the steps of:
querying an information repository in relation to the identified object;
wherein the information repository comprises:
a catalog of a first plurality of identified objects, each arranged in relation an identity thereof; and
an index of the catalog, which relates one or more of the first plurality of identified objects in relation to a second plurality of information sources; and
wherein the second plurality of information sources comprises a source of the associated information; and
in response to the query, indexing the associated information to the identified object;
wherein the providing step comprises the steps of:
linking to the indexed information; and
presenting the associated information in real time or near real time in relation to the media content portion.

3. The method as recited in claim 1 wherein the media content comprises:
at least one of video or image related media content; and
one or more of:
a) an essentially original instance of the media content;
b) an instance of content that conforms substantially to an original instance of the media content;
c) an instance of content that is derived from one or more of the a) instance or the b) instance;
wherein the derivative content instance c) comprises one or more of:
d) a content instance that conforms substantially to one or more of the content instances a) and b); or
e) a content instance that is modified in relation to one or more of the content instances a) or b) in relation to one or more of editing, scaling, transcoding, or distortion.

4. A computer readable storage medium comprising encoded instructions which, when executing over one or more processors of a computer, controls the computer to perform a method, which comprises the steps of:
recognizing at least one object within a portion of media content during one or more of play out or upload of the media content portion;
wherein the object comprises a feature of the media content portion;
associating a plurality of associated information with the object upon recognizing the object; and
ranking each of the plurality of associated information based on relative values of remuneration which were respectively offered for presenting the associated information with the media content portion in which the recognized object appears;
wherein the associating step comprises the steps of:
identifying the recognized object;
mapping the associated information to the identified object; and
providing the associated information with the media content portion; and
wherein the providing step comprises linking to one or more of the plurality of associated information instances based, at least in part, on the ranking step.

5. A system, comprising:
at least one processor; and
a computer readable storage medium that comprises encoded instructions which, when executing over the at least one processor, controls the system to perform a method, which comprises the steps of:
recognizing at least one object within a portion of media content during one or more of play out or upload of the media content portion;
wherein the object comprises a feature of the media content portion;
associating a plurality of associated information with the object upon recognizing the object; and
ranking each of the plurality of associated information based on relative values of remuneration which were respectively offered for presenting the associated information with the media content portion in which the recognized object appears;
wherein the associating step comprises the steps of:
identifying the recognized object;
mapping the associated information to the identified object; and
providing the associated information with the media content portion; and
wherein the providing step comprises linking to one or more of the plurality of associated information instances based, at least in part, on the ranking step.

6. A system, comprising:
means for recognizing at least one object within a portion of media content during one or more of play out or upload of the media content portion;
wherein the object comprises a feature of the media content portion;
means for associating a plurality of associated information with the object upon recognizing the object; and
means for ranking each of the plurality of associated information based on relative values of remuneration which were respectively offered for presenting the associated information with the media content portion in which the recognized object appears;
wherein the associating means comprises:
means for identifying the recognized object;
means for mapping the associated information to the identified object; and
means for providing the associated information with the media content portion; and
wherein the providing means comprises means for linking to one or more of the plurality of associated information instances based, at least in part, on the ranking step.

7. A method, comprising the steps of:
querying an information repository for information that relates to a portion of media content;
wherein the query executes in relation to an object, which comprises a feature of the media content portion; and
returning a search result related to the recognized object;
wherein the returning step comprises the steps of:
recognizing the object;
indexing a plurality of auxiliary information that is associated with the recognized object;
ranking each of the plurality of auxiliary information based on a value of remuneration agreed in exchange for providing the auxiliary information with the search result; and
providing the auxiliary information;
wherein the auxiliary information is presented in real time or near real time with the search result; and
wherein the providing step comprises linking to one or more of the plurality of auxiliary information instances based, at least in part, on the ranking step.

8. A computer readable storage medium comprising encoded instructions which, when executing over one or more processors of a computer, controls the computer to perform a method, which comprises the steps of:
querying an information repository for information that relates to a portion of media content;
wherein the query executes in relation to an object, which comprises a feature of the media content portion; and
returning a search result related to the object;
wherein the returning step comprises the steps of:
recognizing the object;
indexing a plurality of auxiliary information that is associated with the recognized object;
ranking each of the plurality of auxiliary information based on a value of remuneration agreed in exchange for providing the auxiliary information with the search result; and
providing the auxiliary information;
wherein the auxiliary information is presented in real time or near real time with the search result; and
wherein the providing step comprises linking to one or more of the plurality of auxiliary information instances based, at least in part, on the ranking step.

9. A system, comprising:
at least one processor; and
a computer readable storage medium that comprises encoded instructions which, when executing over the at least one processor, controls the system to perform a method, which comprises the steps of
querying an information repository for information that relates to a portion of media content;
wherein the query executes in relation to an object, which comprises a feature of the media content portion; and
returning a search result related to the recognized object;
wherein the returning step comprises the steps of:
recognizing the object;
indexing a plurality of auxiliary information that is associated with the recognized object;
ranking each of the plurality of auxiliary information based on a value of remuneration agreed in exchange for providing the auxiliary information with the search result; and
providing the auxiliary information;
wherein the auxiliary information is presented in real time or near real time with the search result; and
wherein the providing step comprises linking to one or more of the plurality of auxiliary information instances based, at least in part, on the ranking step.

10. A system, comprising:
means for querying an information repository for information that relates to a portion of media content;
wherein the query executes in relation to an object, which comprises a feature of the media content portion; and
means for returning a search result related to the recognized object;
wherein the returning means comprises:
means for recognizing the object;
means for indexing a plurality of auxiliary information that is associated with the recognized object;
means for ranking each of the plurality of auxiliary information based on a value of remuneration agreed in exchange for providing the auxiliary information with the search result; and
means for providing the auxiliary information;
wherein the auxiliary information is presented in real time or near real time with the search result; and
wherein the providing means comprises means for linking to one or more of the plurality of auxiliary information instances based, at least in part, on a function of the ranking means.
